(19) United States
(12) Patent Application Publication
(10) Pub. No.: US 2017/0247875 A1
(43) Pub. Date: Aug. 31, 2017

(54) AUTONOMOUS BEAM ASSEMBLY SYSTEM FOR STEEL STRUCTURE

(71) Applicant: National Taiwan University, Taipei (TW)

(72) Inventors: Ci-Jyun Liang, Taipei (TW); Shih-Chung Kang, Taipei (TW)

(73) Assignee: National Taiwan University, Taipei (TW)

(21) Appl. No.: 15/374,917

(22) Filed: Dec. 9, 2016

Related U.S. Application Data
(60) Provisional application No. 62/265,261, filed on Dec. 9, 2015.

(51) Int. Cl. E04B 1/24; G01B 11/27

(52) U.S. Cl. CPC E04B 1/2403; G01B 11/272; E04B 2001/2415; E04B 2001/2451; E04B 2001/2457; E04B 2103/06; F16H 1/06

(57) ABSTRACT

The present invention relates to a steel structure assembling system. The steel structure assembling system applied to assemble a movable steel beam and a fixed steel structure includes a rotating control device disposed on the movable steel beam for adjusting a relative position of the movable steel beam with respect to the fixed steel structure; an alignment target disposed on the fixed steel structure; and an image sensor disposed on the movable steel beam, sensing a target image of the alignment target and transmitting the target image to a ground operator to render the ground operator to operate the rotating control device to adjust the relative position of the movable steel beam in accordance with the acquired target image.

This application claims benefit of U.S. Provisional Patent Application No. 62/265,261, filed on Dec. 9, 2015, in the United State Patent and Trademark Office, the disclosure of which is incorporated herein its entirety by reference.

### FIELD

The present invention relates to a system and a method for assembly of steel structure, in particular, to a system and a method for adjusting and fine tuning a position of a rigging beam with respect to a fixed steel structure and fast bolting both during assembling operation by using a rotating control device, a set of alignment tool, a bolting steel plate and a set of bolt and nut.

### BACKGROUND

A steel beam assembly process is always in the critical path of a large high-rise steel structure construction project. Therefore, the steel beam assembly process will influence the construction project schedule. To increase the safety and efficiency of steel erection, this research will develop an appropriate steel beam assembly aiding system.

The erection and assembly process always has high percentage cost in steel structure construction project; however, it extremely rely on manual labor. FIGS. 1(a) through 1(d) are schematic diagrams illustrating multiple steps in an erection and assembly process for a steel structure in the prior art. First, the tower crane lifts and transport a steel beam to assembly position, as shown in FIG. 1(a) and FIG. 1(b). Second, laborers align the steel beam to precise position by hand, by cable, or even by foot, as shown in FIG. 1(c). This procedure accounts for high percentage of time spending in process. Finally, laborers assemble the steel beam with steel plates and bolts, as shown in FIG. 1(d). During the process, laborers have to stand on a narrow steel beam in a high-rise place with only a simple safety cable. The falling accident might happen and cause serious injury. Furthermore, the efficiency of process is difficult to control because of manual works.

The safety issue is important in construction project. Accident happening in construction site might cause serious damage. Such as in Taiwan, more than six hundred accidents happen every year and cause hundreds of people injured. Falls from high place, struck by object and electrocutions are three main types of accident happened in construction site. Therefore, protecting human labors is the primary goal to improve construction safety. Techniques have been developed to help maintain safety in construction site. Worker tracking and locating system have helped monitor laborers in construction site and prevent accidents caused by blind spot. The next goal is to remove laborers from construction sites. A remote control tower crane system has been used in an unmanned construction site. Path planning algorithms have been utilized to help transport beams without guidance from laborers at construction sites. Despite these technologies, laborers are still required in high-rise locations to assemble the elevated steel beams to the steel columns.

During the assembling process, the vertical alignment and the horizontal alignment between a rigging beam and a fixed steel structure is a very important operation. In usual, the vertical alignment can be much easier managed than the horizontal alignment, because the elevation of the rigging beam can be relatively easily and precisely adjusted by a crane machine. However, the horizontal alignment by itself is relatively hardly controlled, since it is hard to actively revolve the rigging beam precisely and quickly. Conventionally the labors revolve the beam just by cable or foot as shown in FIG. 1(c). In addition, the location of the beam on a horizontal plane is easily swung and disturbed by the wind.

There is a need to solve the above deficiencies/issues.

### SUMMARY

An autonomous beam assembly system for steel structure is proposed in this disclosure, which aims to improve the safety and the efficiency of the steel beam assembly process. This system is easy-removable, light-weight and low-cost, which fits current erection method and can be broadly introduced to existing construction sites. Removing steel workers from the high place in the construction site during steel beam erection and assembly process prevents falls and accidents due to building collapsing. In addition, the efficiency can easily be controlled since the manual human factor has been excluded from the process. The system was validated by a scaled-down physical experiment.

The system is designed by observing the current steel beam erection and assembly method. It utilizes a rotation method to rotate the rigging beam to the right angle. A vertical and horizontal alignment method is developed to align the beam. A bolting method is developed to assemble the beam. An unloading method is developed to unload the cable.

The present invention proposes a steel structure assembling system applied to assemble a movable steel beam and a fixed steel structure. The system includes a rotating control device disposed on the movable steel beam for adjusting a relative position of the movable steel beam with respect to the fixed steel structure; an alignment target disposed on the fixed steel structure; and an image sensor disposed on the movable steel beam, sensing a target image of the alignment target and transmitting the target image to a ground operator to render the ground operator to operate the rotating control device to adjust the relative position of the movable steel beam in accordance with the acquired target image.

Preferably, the rotating control device further includes a protective case, an electric power, a driving motor, a transmission module, an inertia flywheel, a micro control module, a wireless communication module, a light mark generator and a connector.

Preferably, the light mark generator projects a light mark onto the alignment target and the ground operator operates the rotating control device to adjust the relative position according to an indication made by the light mark on the alignment target shown on the acquired target image.

The present invention further proposes a steel structure assembling method applied to assemble a movable steel beam and a fixed steel structure. The method includes disposing an alignment target on the fixed steel structure; disposing a rotating control device on the movable steel beam, in which the rotating control device including a light mark generator projecting a light mark onto the alignment target; sensing a target image for the alignment target; and adjusting a relative position of the movable steel beam with respect to the fixed steel structure by using a rotating control device disposed on the movable steel beam according to an indication made by the light mark on the alignment target shown on the target image.

Preferably, the method further includes adjusting a vertical elevation of the movable steel beam by a crane machine; performing a vertical alignment by the crane machine; and performing a horizontal alignment by the rotating control device.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIGS. 1(a)-1(d) are schematic diagrams illustrating multiple steps in an erection and assembly process for a steel structure in the prior art;

FIG. 2 is a schematic diagram illustrating multiple major stages including a rotation control operation, a horizontal alignment operation and a bolting operation for an assembly of a steel structure in accordance with the present invention;

FIG. 3 is a schematic diagram illustrating a structure of a rotation box which acts as a rotating control device;

FIG. 4 is a schematic diagram illustrating a movable steel beam configured with a rotating control device that is hung on a crane hook;

FIG. 5 is a graph illustrating the relationship among the inertia for the inertia flywheel I_{w}, the inertia for the rigged beam I_{wb}, the angular velocity for the inertia flywheel ω_{w}, the angular velocity for the rigged beam ω_{b}, the acceleration α, and the accelerating period tₐ;

FIG. 6 is a schematic diagram illustrating a vertical aligning operation in accordance with the present invention;

FIG. 7 is a schematic diagram illustrating a bolting steel plate in accordance with the present invention;

FIG. 8 is a schematic diagram illustrating the image sensor capturing the alignment target in accordance with the present invention;

FIGS. 9(a) and 9(b) are schematic diagrams illustrating a geometric relationship between the image sensor and the alignment target in accordance with the present invention;

FIG. 10(a) is a top-view schematic diagram illustrating a top-side structure for the fixed steel structure and the rigging beam during a horizontal alignment operation in accordance with the present invention;

FIG. 10(b) is a side-viewed schematic diagram illustrating a lateral-side structure for the fixed steel structure and the rigging beam during a horizontal alignment operation in accordance with the present invention;

FIG. 11(a) is a side-viewed schematic diagram illustrating a structure at a plugged status around the joint on the fixed structure during a bolting operation in accordance with the present invention;

FIG. 11(b) is a side-viewed schematic diagram illustrating a structure at an inserted status around the joint on the fixed structure during a bolting operation in accordance with the present invention;

FIG. 11(c) is a cross-section view schematic diagram on the cross section AA in FIG. 11(a) illustrating a structure a plugged status around the joint on the fixed structure during a bolting operation in accordance with the present invention;

FIG. 11(d) is a cross-section view schematic diagram on the cross section AA in FIG. 11(a) illustrating a structure an inserted status around the joint on the fixed structure during a bolting operation in accordance with the present invention;

FIG. 12(a) is a top-viewed schematic diagram illustrating a nut in accordance with the present invention;

FIG. 12(b) is a cross-section view schematic diagram according to the cross-section line AA in FIG. 12(a) illustrating a nut in accordance with the present invention;

FIG. 12(c) is a perspective view schematic diagram illustrating a nut in accordance with the present invention; and

FIG. 13 is a flow chart demonstrating steps required to implement the method for the assembly of a steel structure in accordance with the present invention.

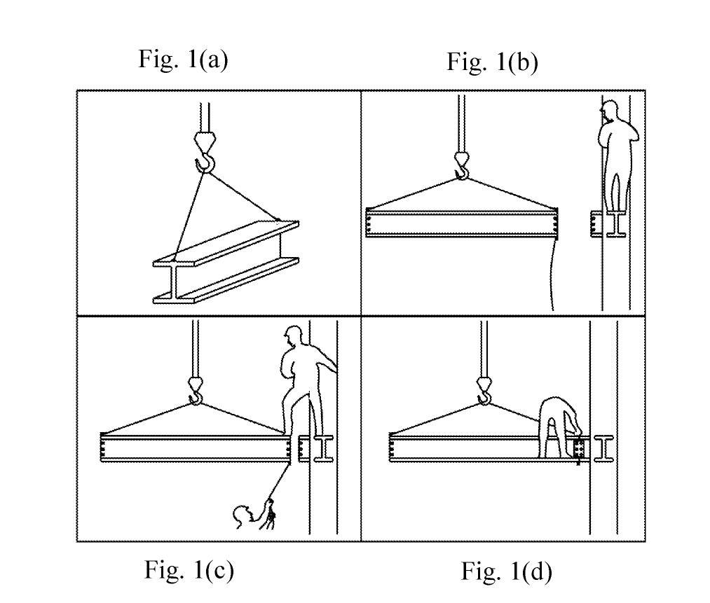

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “comprising” or “including”, used in the claims and specification, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

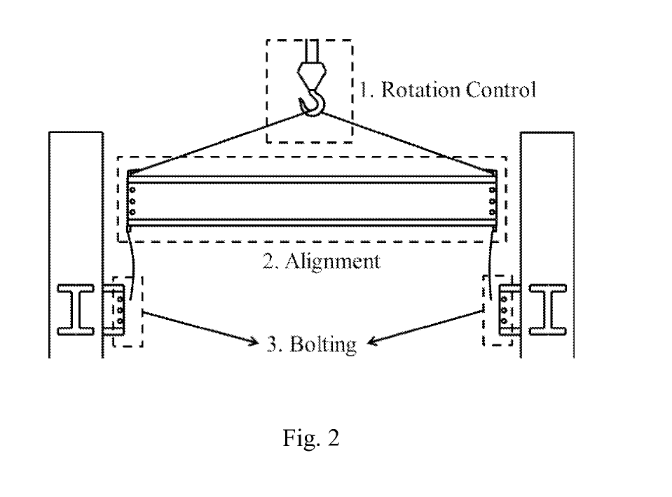

FIG. 2 is a schematic diagram illustrating multiple major stages including a rotation control operation, a horizontal alignment operation and a bolting operation for an assembly of a steel structure in accordance with the present invention. The steel beam erection and assembly process is separated into three steps: a rotating control operation, an alignment operation and a bolting operation, as shown in FIG. 2. First of all, we have to rotate the moveable rigging beam to the correct angle. Second, the beam is aligned to the correct position. Third, the beam is connected to the column with two or three bolts to complete the “temporary connection”.

In the system, at least two workers are required to operate, one of which is the ground operator and another one is the tower crane operator. First, the ground operator attaches the steel beam to the tower crane hook and prepare for the erection. The rigging beam and the system must be adjusted for fully horizontal. Second, the tower crane operator transports the beam to the target position, which is the top of the assembly position, and aligns roughly. Third, the system helps the operator to adjust the height of the beam to a proper level, which the beam can successfully connect to the column later. Fourth, the operator rotates the beam to the right angle, which the steel beam can connect to the column. Fifth, the crane operator adjusts the horizontal position of the beam accurately by the system. Notice that if the beam failed to get to the right position, it has to go back to rotation step and repeat the process. Sixth, the beam is assembled with bolts. The temporary connection is completed after this step. The operators have to check whether all bolts have been assembled. It has to go back to rough alignment step if failed to assemble all bolts. Seventh, the system unloads the beam-hook connecting cable. Eighth, the tower crane removes the system and repositions for the next beam. The method consists of four key methods: the rotation method, the alignment method, the bolting method and the unloading method, which we will provide detail description in the following sections.

The present invention employs the principle of conservation of angular momentum to realize the movements and the rotations to the movable beam. The rotation box with a flywheel is equipped on the top of the rigging beam to generate angular momentum and the beam will generate an inverse angular momentum. The flywheel is rotated by a motor through an axle and gears. A motor controller and a wireless router are used to control the flywheel by the ground operator. When the rigging beam reaches the proper position, the operator turns on the flywheel until the beam rotates to the right angle. The connecter is two pair of the angle steel clipping the beam during the process. The camera and the light signal on the rotation box are used to process the alignment method.

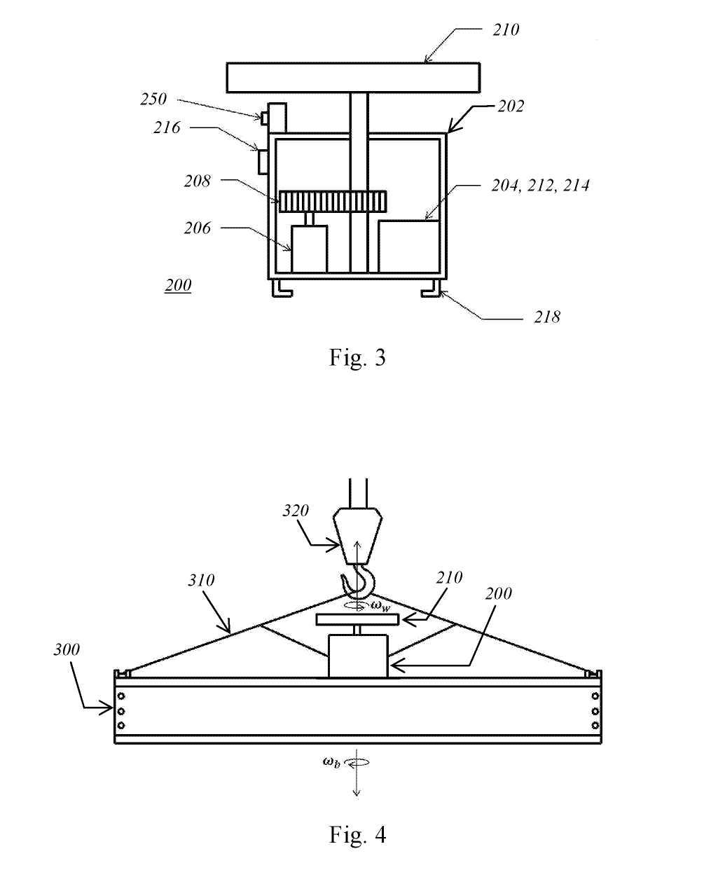

FIG. 3 is a schematic diagram illustrating a structure of a rotation box which acts as a rotating control device. The active rotating control device 200 includes a protective case 202, an electric power 204, a driving motor 206, a transmission module 208, an inertia flywheel 210, a micro control module 212, a wireless communication module 214, a light mark generator 216 and a connector 218. In some embodiments, an image sensor 250 is optionally attached onto the external wall on the protective case 202 on the active rotating control device 200. The image sensor 250 is not included in the active rotating control device 200.

The active rotating control device 200 receives an operating command from a ground operator through the wireless communication module 214 and transmits it to the micro control module 212. The micro control module 212 controls the driving motor 206 to perform the acting actions accordingly. The acting actions include but are not limited to include the start-up, a forward rotation, a reversal rotation, a rotating ratio, and a stop. The electric power the driving motor 206 requires is provided by the electric power 204. The kinematic power generated by the driving motor 206 is sent to the transmission module 208 to drive the inertia flywheel to rotate. The above components are configured inside the protective case 202.

FIG. 4 is a schematic diagram illustrating a movable steel beam configured with a rotating control device that is hung on a crane hook. The protective case 202 on the active rotating control device 200 is attached to and secured onto a movable steel beam 300 through a connector 218. The movable steel beam 300 is a rigging beam ready to align with and connect to the fix steel structure. The movable steel beam 300 is hung on a crane hook 320 through a cable 310 and lifted up by a crane machine. The crane machine is responsible for adjusting a vertical position for the beam 300. The active rotating control device 200 activates the flywheel 210 to generate an angular momentum which correspondingly provides a reversal angular momentum for the beam 300 to drive the beam 300 to perform a horizontal rotation, so as to properly and precisely adjust the position of the beam 300 on the horizontal plane.

A mathematical model of the rotation method is able to be built based on the free body diagram shown by FIG. 4. It assumes the friction between the crane hook 320 and the cable 310 is zero. It also neglects the effect of the wind due to massive weight of the rigging beam 300. The angular velocity of the rigging beam 300 the given by the conservation of angular momentum equation is:

$${ω}_{b} = \frac{{I}_{w}}{{I}_{b}} {ω}_{w} \qquad ( 1 )$$

where I_{w}, I_{b} represent the moment of inertia of the inertia flywheel 210 and the rigged beam 300 and ω_{w}, ω_{b} represent the angular velocity of the flywheel 210 and the rigged beam 300.

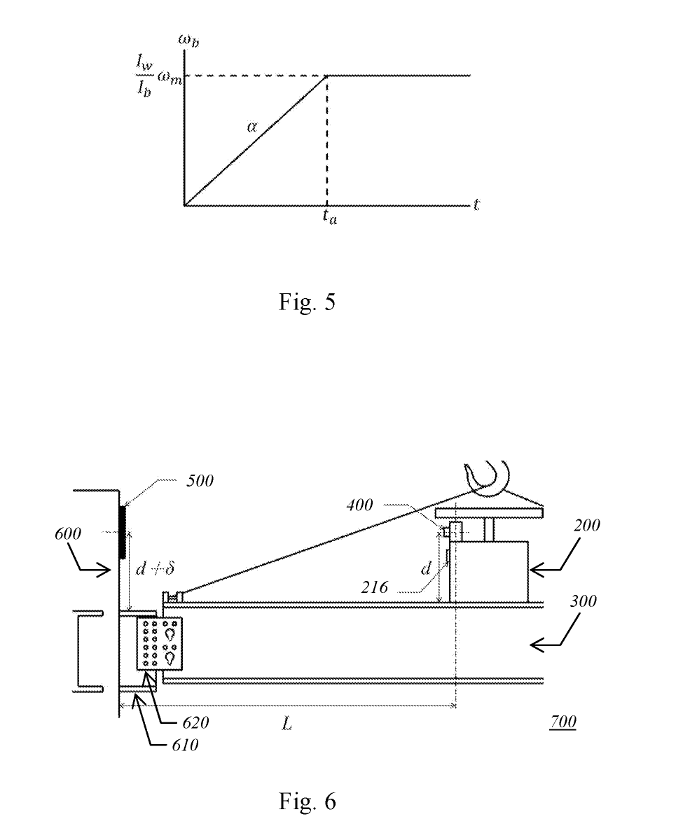

The angular velocity of the inertia flywheel 210 is provided by the driving motor 206 inside the active rotating control device 200 the rotation box, which is also the maximum revolution per minute of the motor ωₘ. The angular velocity of the inertia flywheel 210 has two different periods and each has different description. First is the accelerating period and second is the constant velocity period. In the accelerating period, we assume a constant acceleration a for the inertia flywheel 210 during the process. The angular velocity for the inertia flywheel 210 is ω_{w}=αtₐ, where tₐ is the accelerating period to reach the maximum revolution per minute ωₘ. In the constant velocity period, we assume the angular velocity ω_{w} for the inertia flywheel 210 always reach and maintain the maximum revolution per time. The angular velocity ω_{w} for the inertia flywheel 210 is equal to maximum revolution per time ωₘ. Therefore, the angular velocity of the rigged beam 300 can be derived from the equation (1) and the angular velocity of the inertia flywheel, as shown in FIG. 5.

FIG. 5 is a graph illustrating the relationship among the inertia for the inertia flywheel I_{w}, the inertia for the rigged beam I_{wb}, the angular velocity for the inertia flywheel ω_{w}, the angular velocity for the rigged beam ω_{b}, the acceleration a, and the accelerating period tₐ. In order to select a proper driving motor 206 for the active rotating control device 200, it has to calculate the maximum power Pₘₐₓ of the driving motor 206. It is assumes the angular acceleration a is given from the driving motor 206, and therefore the torque τ of the motor is as follows:

τ=I_{w}α (2)

Wherein I_{w} is the inertia the inertia flywheel generates. Then we can calculate the power P by equations (1) and (2) as follows:

$$P - {τω}_{m} - ( {I}_{w} u ) {ω}_{m} - {I}_{w} \frac{{ω}_{w}}{{t}_{a}} {ω}_{m} \qquad ( 3 )$$

Knowing that when ω_{w}=ωₘ, P is the maximum value

$$P = {P}_{max} = {I}_{w} \frac{{ω}_{m}^{2}}{{t}_{a}} \qquad ( 4 )$$

According to the equation (4) and FIG. 5, it finds out that the maximum revolution Pₘₐₓ per minute of the driving motor and the accelerating period influence the rotating time of the rigging beam and the type of the motor we selected.

The alignment method is divided into two parts: the vertical alignment and the horizontal alignment. The objective of the vertical alignment is to check whether the rigging beam reaches the right height. We use a camera to capture the target on the column and a light signal to inform the operator whether the beam reaches the right height.

FIG. 6 is a schematic diagram illustrating a vertical aligning operation in accordance with the present invention. The steel assembling system 700 includes but is not limited to include an active rotating control device 200, a light mark generator 216, a movable steel beam 300, an image sensor 400, an alignment target 500, a fixed steel structure 600, a joint (corbel) 610, and a steel plate 620.

The alignment target 500 is disposed on the fixed steel structure 600, and the light mark generator 216 and the camera the image sensor 500 are disposed on the rigging beam 300. The ground operating personal can know, handle and mange the movements of the rigging beam 300 on the horizontal plane by observing the reference position the light mark generated by the light mark generator 216 is projected on the alignment target 500. According to the reference position, the ground operating personal can manipulate the active rotating control device 200 to adjust the position of the rigging bema 300 on the horizontal plane, so as to precisely move the rigging beam 300 to the predetermined assembling position on the fixed steel structure 600.

When the movable steel beam 300 is driven and rotated by the active rotating control device 200 to perform a horizontal rotation, the ground operator can manage the displacement of the beam 300, by observing a relative position of the light mark generated by the light mark generator 216 with respect to the alignment target 500. The ground operator can then operate the active rotating control device 200 and the crane machine to precisely control and adjust the beam 300 to move to a predetermined assembling position.

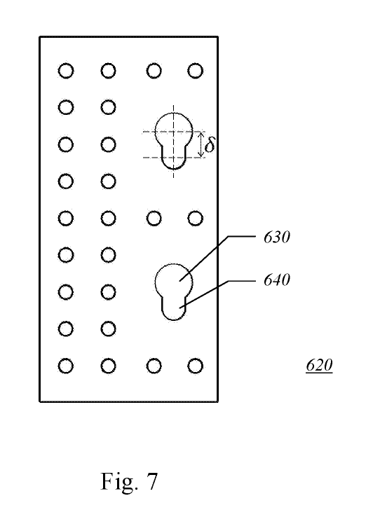

In order to assemble the beam, the vertical alignment position of the rigging beam must be shortly higher than the joint. Length d represents the distance from the central of the camera lens to the beam top surface. Length δ is the vertical distance between the beam and the joint, which is also the distance from central of the plug hole to the bolt hole, as shown in FIG. 7. Therefore, the centroid of the alignment target 500 is d+δ higher from the joint. Length L is the distance from central of the camera lens to the column, which we will use to determine the target size.

In brief, the inertia flywheel included in the active rotating control device is utilized to adjust the relative position on a horizontal plane for the movable steel beam with respect to the fixed steel structure. The ground operating personal can easily operate the inertia flywheel to adjust the revolving angle for the rigging beam 300 to put it on the right position for assembling. The alignment tool including the light mark generator, the image sensor and the alignment target are utilized to perform the vertical and horizontal alignments.

FIG. 7 is a schematic diagram illustrating a steel plate in accordance with the present invention. The steel plate 620 in the present invention is used for securing onto the joint 610 on the fixed steel structure 600, to link the movable steel beam 300 and the joint 610 on the fixed steel structure 600. The steel plate 620 includes multiple opens, and each opens includes a plug hole 630 and a bolt hole 640.

In order to assemble movable steel beam 300, at the initial stage, the height of the movable steel beam 300 should be slightly higher than that of the steel plate 620 on the fixed steel structure 600. As shown in FIG. 6, the length d represents the distance from the central of the camera lens of the image sensor 250 to the top surface of the beam 300. Length 8 is the vertical distance between the beam 300 and the joint 610, which is also the distance from central of the plug hole 630 to the bolt hole 640, as shown in FIG. 7. Therefore, the centroid of the target is d+δ higher from the joint 610. Length L is the distance from central of the camera lens of the image sensor 250 to the column of the fixed steel structure 600, which we will use to determine the target size. When configuring the alignment target 500, it shall control the height from the alignment target 500 to the joint 610 to be less than d+δ.

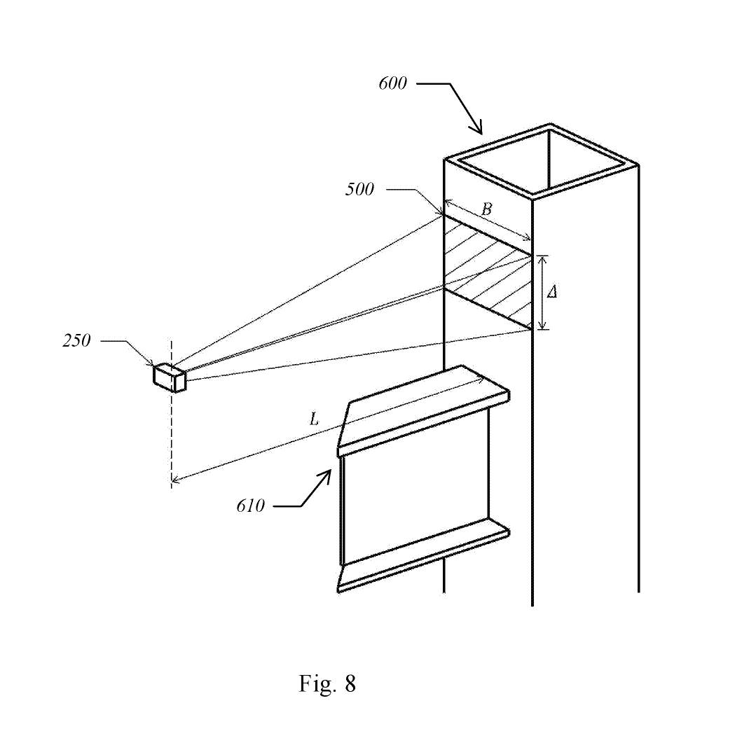

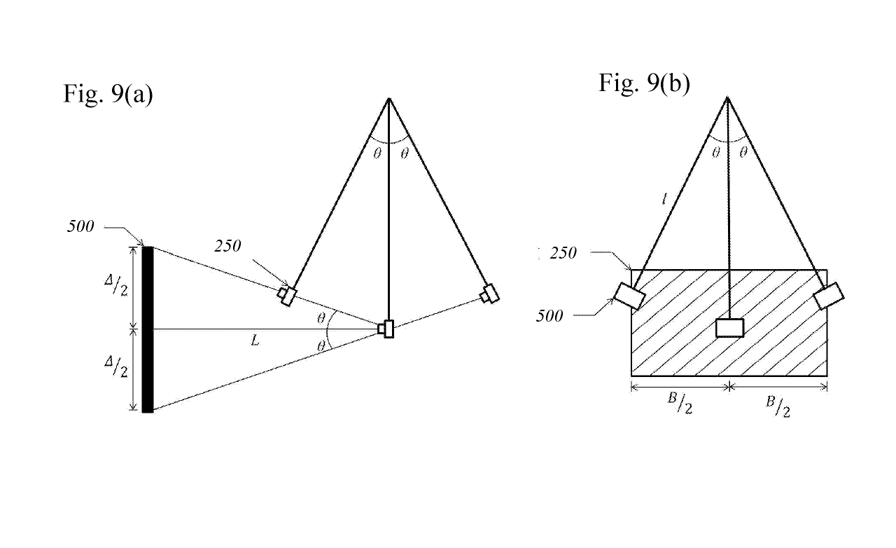

FIG. 8 is a schematic diagram illustrating the image sensor capturing the alignment target in accordance with the present invention. FIGS. 9(a) through 9(b) are schematic diagrams illustrating a geometric relationship between the image sensor and the alignment target in accordance with the present invention. The camera captures the image and searches for the target, as shown in FIG. 8. If the beam reached the right level, the target can be found on the image and the light signal will inform the operator. The target size is influenced by the erection swag. FIG. 9 shows the mathematical model of the influence to the target size due to the erection swag. It is assumed the target length Δ is

Δ=4L tan θ (5)

where L represents the distance between the camera and the column and θ represents the pendulum angle. The pendulum equation, according to Kuo and Kang, is as follows:

$$\frac{{d}^{2} θ}{{dt}^{2}} = \frac{a}{l} cos 0 - \frac{g}{l} sin 0 \qquad ( 6 )$$

where α represents the crane operation acceleration, l represents the crane cable length and g represents the gravity. The target width B is as follows:

B=2l sin θ (7)

Therefore, we can determine the target length A and width B with the equations (5), (6) and (7).

During the alignment process, it is notified to keep the image sensor 250 to point toward the right direction, namely to point toward the alignment target 500. Then the ground operator can calibrate and adjust the pointing direction of the image sensor 250 before operating. The camera has to stay at the right orientation during the rough and vertical alignment, which is the direction to the column; we use a gyro sensor and a motor to control the orientation of the camera. Before the vertical alignment step starts, the motor will rotate the camera to the column direction.

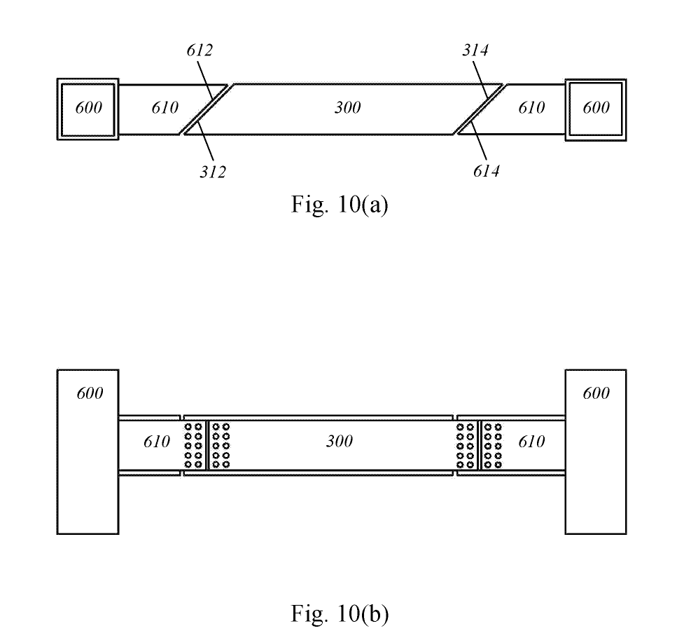

FIG. 10(a) is a top-view schematic diagram illustrating a top-side structure for the fixed steel structure and the rigging beam during a horizontal alignment operation in accordance with the present invention. FIG. 10(b) is a side-viewed schematic diagram illustrating a lateral-side structure for the fixed steel structure and the rigging beam during a horizontal alignment operation in accordance with the present invention. During the horizontal alignment operation, the both terminal ends must be well aligned with the joint 610 on the fixed steel structure 600. In convention, the both edges 312 and 314 on both terminal ends of the beam are in a rectangular shape. Thus the rigging beam 300 can be easily trolled by tower crane because of the shape in case the beam is not at the right position. In order to enhance the horizontal alignment efficiency for the rigging beam 300, the present invention further proposes a modification for the shapes of both edges on both terminal ends of the rigging beam.

The present invention modifies the shapes of the both edges 312 and 314 on both terminal ends of the beam to have an angled cut shape or a miter cut shape. Correspondingly, the shapes of the both edges 612 and 614 on the both joint 610 are modified in correspondence with, in compensation with or in compatible with the shapes on both edges 312 and 314 on both terminal ends of the beam, to have an angled cut shape or a miter cut shape as well. The objective of the horizontal alignment is to adjust the rigging beam to the assigned position. In a top view, we change the shape of the flange plates into parallelogram so that the beam will not get stuck during the rotation process. The bolting steel plates are used to validate the accuracy of the alignment. The operator has to check whether all bolts are plug into the plug holes.

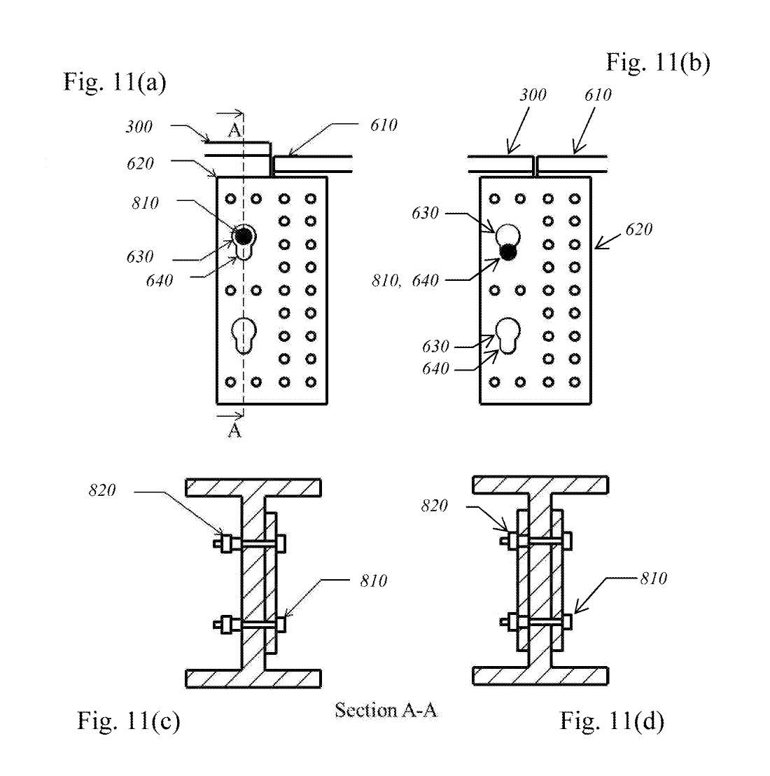

FIG. 11(a) is a side-viewed schematic diagram illustrating a structure at a plugged status around the joint on the fixed structure during a bolting operation in accordance with the present invention. FIG. 11(b) is a side-viewed schematic diagram illustrating a structure at an inserted status around the joint on the fixed structure during a bolting operation in accordance with the present invention. FIG. 11(c) is a cross-section view schematic diagram on the cross section AA in FIG. 11(a) illustrating a structure a plugged status around the joint on the fixed structure during a bolting operation in accordance with the present invention. FIG. 11(d) is a cross-section view schematic diagram on the cross section AA in FIG. 11(a) illustrating a structure an inserted status around the joint on the fixed structure during a bolting operation in accordance with the present invention.

For providing a faster bolting process operation, we use “plug and play” method instead of traditional “tighten bolts” method. We add two additional plug holes 630 through the bolt holes 640 because only two bolts are needed for temporary connection. As already shown in FIG. 7, the steel plate 620 includes multiple opens, and each opens includes a plug hole 630 and a bolt hole 640 connected with each other, in which the plug hole 630 has a diameter larger than that of the bolt hole 640. The bolting steel plates were assembled to the corbel and the rigging beam before erection. After finishing the horizontal alignment, the bolts have been plugged into the plug holes. The crane operator then releases the rigged beam and the bolts will slide into the bolt holes, as shown in FIG. 11, and the bolts assembly step is completed.

In some embodiments, as shown in FIGS. 11(a) through 11(c), the bolting steel plate 620 is already assembled on the joint 610. When the beam 300 is revolved to a spot close to the steel plate 620, it is estimated to make the beam 300 to align with the steel plate 620 roughly. As described above, it shall make the height of the beam 300 to be larger than that of the steel plate 620, that is to control the distance from the centroid of the alignment target 500 to the joint 610 shall be higher than d+δ. Next a worker insets the bolt 810 into the plug hole 630 on the steel plate 620 to temporally secure the beam 300. Then the crane machine slowly releases or drop down the beam 300 and the bolt 810 automatically slides from the plug hole 630 into the bolt hole 640. As shown in FIGS. 11(b) and 11(d), the worker then fastens the bolt with a nut 820. It is to be noticed since the diameter of the plug hole 630 has is larger than that of the bolt hole 640, it allows the beam 300 to approximately align with the steel plate 620.

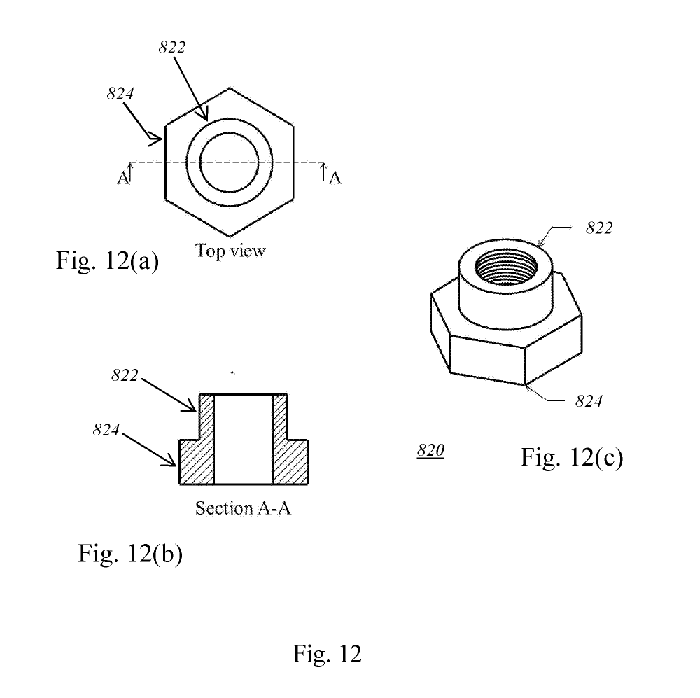

FIG. 12(a) is a top-viewed schematic diagram illustrating a nut in accordance with the present invention. FIG. 12(b) is a cross-section view schematic diagram on the cross-section line AA in FIG. 12(a) illustrating a nut in accordance with the present invention. FIG. 12(c) is a perspective view schematic diagram illustrating a nut in accordance with the present invention.

We have designed a new nut for this method, as shown in FIGS. 12(a) through 12(c). The nut 820 has two parts, the slide part 822 and the assembly part 824. The slide part 822 is used to assemble the bolting steel plate 620 to the beam 300 and slide down through the plug hole 630 to the bolt hole 640. Then the beam 300 will be assembled by the assembly part 824 and achieve the temporary connection.

The unloading method is used to remove the system and unload the cable. We use wire to connect the rotation box to the crane hook. Therefore, the system can be removed by tower crane during the reposition step. The cable connecting to the rigging beam also needs to be unloaded. We use pin mechanism, wire and motor to achieve the unloading method. The wire attaches to the pin and the motor. After the bolting assembly step completed, the motor start to roll the wire and extract the pin from the mechanism. Then, the cable is unloaded from the rigged beam and can reposition for the next target.

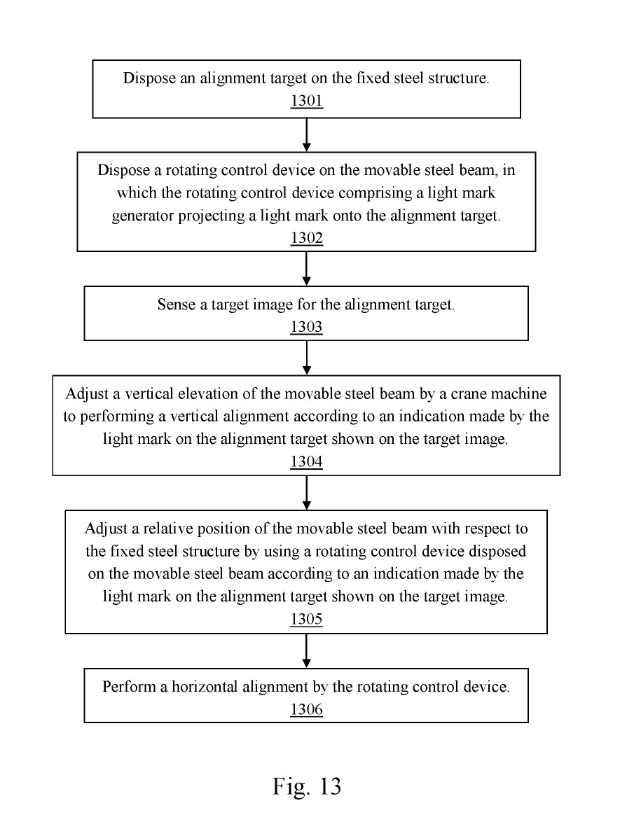

FIG. 13 is a flow chart demonstrating steps required to implement the method for the assembly of a steel structure in accordance with the present invention. Accordingly, it is easily to conclude the following multiple steps for performing a vertical and horizontal alignment for assembling a steel structure by using the above steel structure assembling method, as correspondingly demonstrated in FIG. 13.

Step 1301: disposing an alignment target on the fixed steel structure. Step 1302: disposing a rotating control device on the movable steel beam, in which the rotating control device comprising a light mark generator projecting a light mark onto the alignment target. Step 1303: sensing a target image for the alignment target. Step 1304: adjusting a vertical elevation of the movable steel beam by a crane machine to performing a vertical alignment according to an indication made by the light mark on the alignment target shown on the target image. Step 1305: adjusting a relative position of the movable steel beam with respect to the fixed steel structure by using a rotating control device disposed on the movable steel beam according to an indication made by the light mark on the alignment target shown on the target image. Step 1306: performing a horizontal alignment by the rotating control device.

There are further embodiments provided as follows.

Embodiment 1: A steel structure assembling system applied to assemble a movable steel beam and a fixed steel structure includes a rotating control device disposed on the movable steel beam for adjusting a relative position of the movable steel beam with respect to the fixed steel structure; an alignment target disposed on the fixed steel structure; and an image sensor disposed on the movable steel beam, sensing a target image of the alignment target and transmitting the target image to a ground operator to render the ground operator to operate the rotating control device to adjust the relative position of the movable steel beam in accordance with the acquired target image.

Embodiment 2: The system as described in Embodiment 1, the rotating control device further includes a protective case, an electric power, a driving motor, a transmission module, an inertia flywheel, a micro control module, a wireless communication module, a light mark generator and a connector.

Embodiment 3: The system as described in Embodiment 1, the light mark generator projects a light mark onto the alignment target and the ground operator operates the rotating control device to adjust the relative position according to an indication made by the light mark on the alignment target shown on the acquired target image.

Embodiment 4: The system as described in Embodiment 1, the fixed steel structure has a joint used for connecting with the movable steel beam and the joint has a jointing end in a joint form selected from an angled cut shape and a miter cut shape.

Embodiment 5: The system as described in Embodiment 4, the movable steel beam is connected with the joint and has a connecting end used for connecting with the jointing end, which the connecting end has a connecting form selected from an angled cut shape and a miter cut shape, which the connecting form is corresponding to the joint form on the jointing end.

Embodiment 6: The system as described in Embodiment 1 further includes a steel plate having a plug bolt hole including a plug hole and a bolt hole connected with each other, in which the plug hole has a diameter larger than that of the bolt hole; a nut including a slide part and an assembly part; and a bolt fastened with the nut.

Embodiment 7: The system as described in Embodiment 6, the joint and the movable steel beam are disposed with the steel plate.

Embodiment 8: The system as described in Embodiment 6, the bolt hole is used for containing the bolt.

Embodiment 9: A steel structure assembling method applied to assemble a movable steel beam and a fixed steel structure includes disposing an alignment target on the fixed steel structure; disposing a rotating control device on the movable steel beam, in which the rotating control device including a light mark generator projecting a light mark onto the alignment target; sensing a target image for the alignment target; and adjusting a relative position of the movable steel beam with respect to the fixed steel structure by using a rotating control device disposed on the movable steel beam according to an indication made by the light mark on the alignment target shown on the target image.

Embodiment 10: The method as described in Embodiment 9 further includes adjusting a vertical elevation of the movable steel beam by a crane machine; performing a vertical alignment by the crane machine; and performing a horizontal alignment by the rotating control device.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

1. (canceled)

2. (canceled)

3. A steel structure assembling system applied to assemble a movable steel beam and a fixed steel structure, comprising:
a rotating control device disposed on the movable steel beam for adjusting a relative position of the movable steel beam with respect to the fixed steel structure;
an alignment target disposed on the fixed steel structure; and
an image sensor disposed on the movable steel beam, sensing a target image of the alignment target and transmitting the target image to a ground operator to render the ground operator to operate the rotating control device to adjust the relative position of the movable steel beam in accordance with the acquired target image.

4. The system as claimed in claim 3, wherein the rotating control device further comprises a protective case, an electric power, a driving motor, a transmission module, an inertia flywheel, a micro control module, a wireless communication module, a light mark generator and a connector.

5. The system as claimed in claim 3, wherein the light mark generator projects a light mark onto the alignment target and the ground operator operates the rotating control device to adjust the relative position according to an indication made by the light mark on the alignment target shown on the acquired target image.

6. The system as claimed in claim 3, wherein the fixed steel structure has a joint used for connecting with the movable steel beam and the joint has a jointing end in a joint form selected from an angled cut shape and a miter cut shape.

7. The system as claimed in claim 6, wherein the movable steel beam is connected with the joint and has a connecting end used for connecting with the jointing end, which the connecting end has a connecting form selected from an angled cut shape and a miter cut shape, which the connecting form is corresponding to the joint form on the jointing end.

7. The system as claimed in claim 3, further comprising
a steel plate having a plug bolt hole comprising a plug hole and a bolt hole connected with each other, in which the plug hole has a diameter larger than that of the bolt hole;
a nut comprising a slide part and an assembly part; and
a bolt fastened with the nut.

9. The system as claimed in claim 8, wherein the joint and the movable steel beam are disposed with the steel plate.

10. The system as claimed in claim 8, wherein the bolt hole is used for containing the bolt.

11. A steel structure assembling method applied to assemble a movable steel beam and a fixed steel structure, comprising:
disposing an alignment target on the fixed steel structure;
disposing a rotating control device on the movable steel beam, in which the rotating control device comprising a light mark generator projecting a light mark onto the alignment target;
sensing a target image for the alignment target; and
adjusting a relative position of the movable steel beam with respect to the fixed steel structure by using a rotating control device disposed on the movable steel beam according to an indication made by the light mark on the alignment target shown on the target image.

12. The method as claimed in claim 11, further comprising:
adjusting a vertical elevation of the movable steel beam by a crane machine;
performing a vertical alignment by the crane machine; and
performing a horizontal alignment by the rotating control device.
